(19) United States
(12) Patent Application Publication
(10) Pub. No.: US 2008/0289700 A1
(43) Pub. Date: Nov. 27, 2008

(54) High pressure safety valve, system and method

(76) Inventor: Levi D. Masingale, Los Lunas, NM (US)

Correspondence Address: Southwest Intellectual Property Services, LLC, 9400 Holly Avenue NE, Building 4, Albuquerque, NM, 87122, US

(21) Appl. No.: 12/154,737

(22) Filed: May 27, 2008

Related U.S. Application Data
(60) Provisional application No. 60/931,561, filed on May 24, 2007.

(51) Int. Cl. F16K 17/00

(52) U.S. Cl. 137/461; 251/75

(57) ABSTRACT

The present invention comprises, in one embodiment, a compression safety valve apparatus adapted to engagingly connect to an existing gas cylinder valve. In one embodiment, the present invention comprises a housing base having a first bore, a rupture disc holding means having a second bore, at least one rupture disk, a piston having at least a third bore, a spring, and an outer housing cylinder having a forth bore, the first bore, the second bore and the third bore all being in gas flow communication with the compressed content of the tank. In operation, for example, during an over-pressurization event occurs, the extreme force of the escaping gas places a force on the bottom surface of the present invention's rupture disc assembly, so that the piston's beveled surface substantially mechanically engages the outer housing's upper ceiling. This mechanical engagement allows gas to continue to escape from the tank through one or more bleeder bores and a gap.

### PRIORITY CLAIM

The present invention claims priority from U.S. Provisional Patent Application No. 60/931,561, filed May 24, 2007 and entitled “High Pressure Safety Valve”.

### FIELD OF INVENTION

The present invention relates generally to safety valves used in conjunction with pressurized gas or fluid cylinders, tanks or like units, wherein such safety valves are designed to substantially reduce or shut off the flow of compressed content from the cylinder when rapid release of the compressed content within the cylinder occurs.

### BACKGROUND OF THE INVENTION

It is well known in the art that pressurized gas or fluid is capable of performing tremendous amount of work. However, it is also known in the art that a sudden release of compressed gas or fluid from the cylinder, such as may occur during the rupture of the valve on a high pressure tank, may be extremely hazardous to those people or damaging to property within the vicinity of the tank.

FIG. 1 illustrates a typical prior art gas cylinder having a typical prior art shutoff valve 100. The shutoff valve 100 is a manual screw-type valve that controls whether or not gas flows out of the tank through the shutoff valve, and then to the valve's outlet. An optional pressure gauge or pressure regulator may be attached or coupled to an outlet valve 103 on the valve 100, and a primary rupture disc assembly 109 may be attached to another (usually opposite) plug in the valve. The shutoff valve 100 is designed to control gas flow according to how far the shutoff valve is opened by turning a handle, but typically, the outlet is connected to an outlet line that has some form of regulator or flow controller for more effective and accurate flow control. Other elements in a conventional gas cylinder are disclosed in U.S. Pat. No. 5,007,548, for example. Namely, conventional gas cylinders are fitted with a valve 100 having a primary rupture disc assembly 109 in an inlet/outlet port 101, a pressure regulator and a series of internal female threads 105 on a bottom bore of valve 100. The pressure regulator (typically insertable into outlet 103) may be pre-programmed for a desired pressure flow setting to a external line connection or hose depending upon the application and the type of content required from the tank. The primary rupture disc assembly 109 has at least one hole 109a formed in its head. The primary rupture disc assembly 109 also includes an internal rupture disc which, in a ruptured state, allows holes 109a to be in gas flow communication with the content within the pressurized tank. Thus, if the tank ever become over-pressurized at a predetermined pressure rating, the primary rupture disc will blow, thereby allowing the content to escape in several radial directions through holes 109a. In this situation, the tank does not become a missile or projectile, as the escaping gas is escaping in several directions through the primary rupture disc assembly 109a (and not a single, linear direction).

While female threads 105 are formed into most valves 100 used in or in conjunction with compressed tanks 100, these threads are typically never used by the valve 100 when the valve 100 is used on or in conjunction with a conventional gas cylinder. Rather, the valve 100 is designed for a number of other uses, including for mechanical coupling to long gas lines in order to control the flow pressure in the long gas lines. When used in this fashion, female threads 105 are adapted to mechanically communicate with corresponding male threads on the gas lines for ease of coupling and use with the long gas lines. As such, because valves 100 may be used in different applications, such valves are automatically formed with female threads 105, whether such threads will be used later in an application or not.

As seen in FIG. 1, conventional gas cylinders are typically sold and shipped with the shutoff valve 100 already attached to one of the longitudinal ends of the gas cylinder, the valve 100 being attached to the cylinder by screwing the valve's male thread 107 into a corresponding female pipe threaded tank opening in the tank. While the shutoff valve 100 is protected during shipping and storage by a valve cover, the valve cover must be removed in order to connect and use an outlet line for access to the compressed content (e.g., gas, liquid, or combination thereof) stored within the tank. Moreover, the location of the primary rupture disc in the inlet/outlet port 101 presents problems when the valve is sheared from the tank, thereby making the rupture disc useless.

Equipment that is used to compress or transfer gases to a tank is expensive, and it is a common practice to compress and transfer the gas at a central location and thereafter, transport the compressed gas within the high-pressure tanks or cylinders. Compressed gas is often stored in reusable cylinders or tubes, which are generally elongated and round in shape. When transported, the cylinders are typically loaded on to a flat bed truck, and placed side-by-side in a box frame or some other support structure which can prevent the cylinders from falling or otherwise banging substantially against one another. These cylinders can be as destructive as a missile should they rupture because of the high pressure at which these tanks are maintained. As a consequence, there is generally only one opening in the tank for permitting access (inlet/outlet) to the gas contained within the tank. Such openings in the tank are of a predetermined, smaller width, and are female threaded to permit the connection of a closure valve or shutoff valve 100 either of which are exceedingly rugged in their construction, but nevertheless are weaker than the tank structure itself.

If the tanks are accidentally dropped or the valve structures on the tank or otherwise hit or sheared off (e.g., due to a lateral impact), the valve body may externally shear from the cylinder upon which it is mounted. The violent release of gas which occurs when the valve bodies are broken produces a tremendous thrust capable of blowing or moving a tank through solid brick wall. However, such compressed gas cylinders are required by law to be fitted with a relief device which are adapted to relieve pressure from the compressed gas cylinders in the event of an over-pressurized cylinder or other extreme danger (e.g., a fire event—as used herein, the term “over-pressurization event” refers to any event which would cause the contents stored in a tank to suddenly be released in an uncontrolled fashion). Such relief devices are typically fitted within the compressed gas cylinder's inlet/outlet valve. This method is popular, because it only requires modification of the existing cylinder's inlet/outlet valve and does not require any modification to the gas cylinder itself. However, the vast majority of relief devices are displaced within the inlet/outlet valve at a point outside (or, exterior to) the cylinder. In such situations, the relief devices are prone to being sheared off (or away from) the compressed gas cylinder (such as may happen during the cylinder unexpectedly falling from a truck onto a hard surface, for example). When the relief devices are sheared off of the compressed gas cylinder, the compressed gas is likely to rapidly escape from the cylinder because now, there is an uncontrolled opening in the cylinder. In most instances, the rapid release of compressed gas is an extreme danger to anyone in range of the compressed gas cylinder because the gas cylinder can now act as a potential missile or similar projectile. In some situations, the surrounding buildings and equipment are also prone to damage, thereby exacerbating the danger potential. Additionally, if the gas is flammable, a rapid release of flammable gas may result in a severe explosion. Because of these types of potential dangers, tanks typically have an inverted cup-shaped metal valve cover which screws onto the tank to protectively cover the shutoff valve. In other designs, the tank may have a collar surrounding and protecting the valve from lateral impact. These types of designs are common on propane tanks for barbecue grills.

As stated previously, numerous safety relief valves exist. For example, U.S. Pat. No. 3,930,517, entitled “Safety Valve”, discloses a multi-chambered safety valve apparatus for use with compressed gas cylinders. This disclosure requires that existing valves be modified for operation. In use, a safety rod is used to push a valve down into an open position. A spring is thereafter used to press a second valve to close the full flow of pressurized gas up to a predetermined pressure value. This disclosures deficient because it requires a modification of existing valves. This disclosure is also deficient because it does not provide any internal relief disk truly prescient he cylinder reaches extremely high pressures.

U.S. Pat. No. 5,941,268, entitled “Tank Safety Valve”, discloses a breakaway safety valve, which is purposely designed to have a weakened section formed in the valve stem. When the valve is broke (or, otherwise sheared off or away) from the cylinder, the weakened section of the valve is designed to break away from the overall valve body, thereby allowing a spring check valve (still attached to the stem within the cylinder) to shut off the escape of any compressed gas. This disclosure, too, suffers in that it requires a complete modification of existing safety valve systems. Moreover, this disclosure is not capable of resetting itself, so that the entire (broken) gas cylinder must be repaired at the next available time. This delay leads to loss of income, as well as lost time and resources. U.S. Patent Application Publication No. 2006/0065303, entitled “Tank Safety Valve”, is a similar disclosure.

U.S. Pat. No. 7,066,193 B2, entitled “Poppet Shear Protection Apparatus and System”, discloses a safety valve that relies on a seat plug to plug up (or, otherwise prevent the escape of) rapid release of gas from a compressed cylinder. In operation, the seat plug is pushed into a poppet by the force rapidly escaping compressed gas (as will happen if the valve is broken or sheared). Because this disclosure has a fixed seat plug, it will only shut off pressure if the existing valve breaks. Moreover, this disclosure cannot reset itself after a shear event, and while this disclosure may prevent rapid decompression of the gas cylinder, when a shear event occurs, the entire valve must thereafter be replaced. Moreover, this disclosure has no internal relief device. Again, while this device is used for over pressure of pressurized gas cylinders, it too suffers because it has no internal relief device president.

U.S. Pat. No. 7,152,617 B1, entitled “High Pressure Release Safety Valve Assembly”, discloses a high-pressure release safety valve assembly which serves to prevent the uncontrolled release of high-pressure gas from the cylinder. In operation, this disclosure requires that the gas cylinder be in an upright or substantially upright position at all times. While this disclosure may prevent the uncontrolled release of gas in the cylinder, it does so through a series of the bleeder veins designed into a poppet bleeder valve, the veins allowing the slow release of high-pressure gas from the cylinder until the cylinder's gas is completely exhausted. As such, well, this disclosure may prevent the high or extreme release of gas from a cylinder, this disclosure also allows the entire contents of the gas cylinder to empty out, albeit slowly.

It is therefore highly desirable to provide a safety release valve for pressurized gas tanks which eliminates many of the hazards commonly occurring when a gas cylinder valve is inadvertently knocked off or sheared from the tank on which it is installed. Accordingly, what is needed is an improved safety valve for compressed gas cylinders and tanks which can easily be retrofitted into existing valve stems, can immediately stop the release of compressed gas, and is self-resetting for continued use of the compressed gas cylinder.

### SUMMARY OF THE INVENTION

The following summary of the invention is provided to facilitate an understanding of some of the innovative features unique to the present invention, and is not intended to be a full description of variations that may be apparent to those of skill in the art. A full appreciation of the various aspects of the invention can be gained from the entire specification, claims, drawings, and abstract taken as a whole.

The present invention comprises generally, a compression safety valve apparatus adapted to engagingly connect to an existing gas cylinder valve. In one embodiment, the present invention comprises a housing base having a first bore, a rupture disc holding means having a second bore, at least one rupture disk, a piston having at least a third bore, a spring, and an outer housing cylinder having a forth bore, the first bore, the second bore and the third bore all being in gas flow communication with the compressed content of the tank. In operation, for example, during an over-pressurization event occurs, the extreme force of the escaping gas places a force on the bottom surface of the present invention's rupture disc assembly, so that the piston's beveled cylindrical surface substantially mechanically engages upper beveled ceiling. This mechanical engagement allows gas to continue to escape from the tank through one or more bleeder bores and a gap.

This disclosure describes numerous specific details that include specific structures and elements, their particular arrangement, and their particular functions in order to provide a thorough understanding of the present invention. One skilled in the art will appreciate that one may practice the present invention without the specific details.

In yet another embodiment, the present invention comprises a method for substantially reducing gas leakage from an over-pressurized tank filled with pressurized content. In still another embodiment, the present invention is a system for providing substantially reducing gas leakage from an over-pressurized tank filled with pressurized content.

The novel features of the present invention will become apparent to those of skill in the art upon examination of the following detailed description of the preferred embodiment or can be learned by practice of the present invention. It should be understood, however, that the detailed description of the preferred embodiment and the specific examples presented, while indicating certain embodiments of the present invention, are provided for illustration purposes only because various changes and modifications within the spirit and scope of the invention will become apparent to those of skill in the art from the detailed description, drawings and claims that follow.

### BRIEF DESCRIPTION OF THE DRAWINGS

The accompanying figures further illustrate the present invention and, together with the detailed description of the preferred embodiment, assists to explain the general principles according to the present invention.

FIG. 1 illustrates a side cutaway view of a conventional compressed content tank, cylinder or like device;

FIG. 2 illustrates a top side perspective view of one embodiment of the present invention;

FIG. 3 illustrates a top side exploded view of the invention illustrated in FIG. 2;

FIG. 4 illustrates a bottom side perspective view of the invention illustrated in FIG. 2;

FIG. 5 Is a bottom side exploded view of the embodiment illustrated in FIG. 4;

FIG. 6 Is a side cutaway view of representative required and optional elements comprising, in one embodiment, the present invention;

FIG. 7 illustrates a side cutaway view of an exemplary housing base of the present invention;

FIG. 8 is a top side plan view of the element illustrated in FIG. 7;

FIG. 9 illustrates a side cutaway view of a exemplary rupture disc holding means of the present invention;

FIG. 10 is a top side plan view of the element illustrated in FIG. 9;

FIG. 11 illustrates a side cutaway view of a exemplary piston of the present invention;

FIG. 12 is a top side plan view of the element illustrated in FIG. 11;

FIG. 13 illustrates a side cutaway view of a representative outer housing cylinder of the present invention;

FIG. 14 is a top side plan view of the element illustrated in FIG. 13;

FIG. 15A is a side cutaway view of one embodiment of the present invention, illustrating the gas or fluid flow through the invention when used in normal operation with a conventional compressed gas or fluid tank or cylinder;

FIG. 15B is a side cutaway view of the embodiment shown in FIG. 15A, here, illustrating the gas or fluid flow through the invention when an over-pressurization event occurs within a conventional compressed gas or fluid tank or cylinder;

FIG. 15C is a side cutaway view of the embodiment shown in FIG. 15A, here, illustrating the gas or fluid flow through the invention when the valve is sheared off of a conventional compressed gas or fluid tank or cylinder; and

FIG. 15D illustrates one embodiment of the present invention as it mechanically couples with a valve within a conventional compressed gas or fluid tank or cylinder, here, illustrating the gas or fluid flow through the invention when the invention's rupture disc and the valve's primary rupture disc fail.(or, otherwise blow).

Additional aspects of the present invention will become evident upon reviewing the non-limiting embodiments described in the specification and the claims taken in conjunction with the accompanying figures, wherein like reference numerals denote like elements.

### DETAILED DESCRIPTION OF THE PREFERRED EMBODIMENT

The present invention is a high pressure, compression safety valve apparatus, system and method which is adapted for internal mechanical coupling to a valve typically used with or on a conventional compressed gas cylinder, tank or container, and which does not require any modification to existing inlet/outlet valves found on conventional compressed gas cylinder tanks.

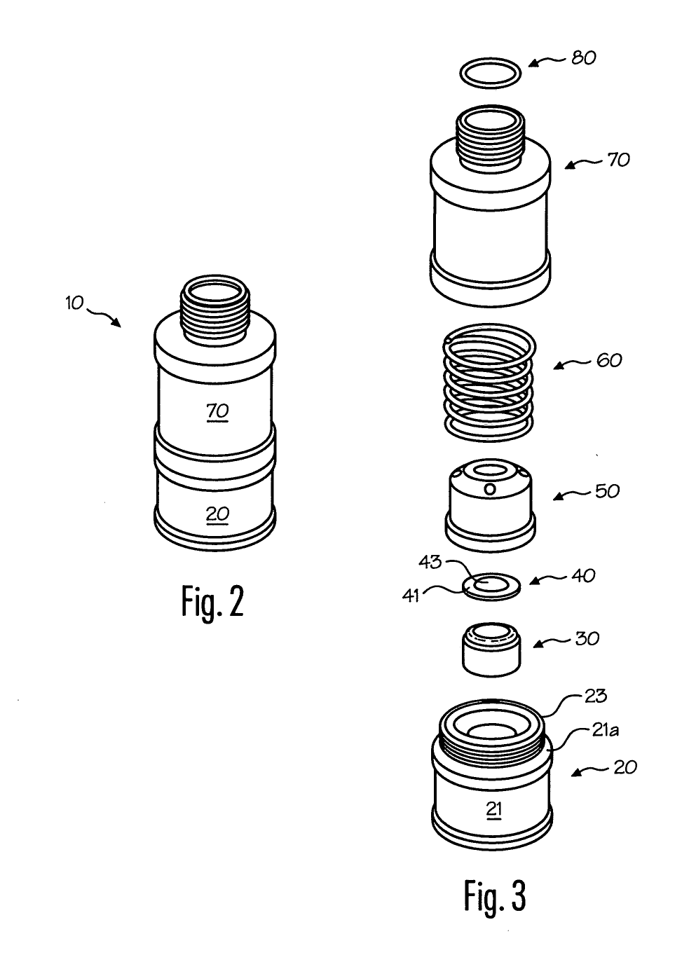

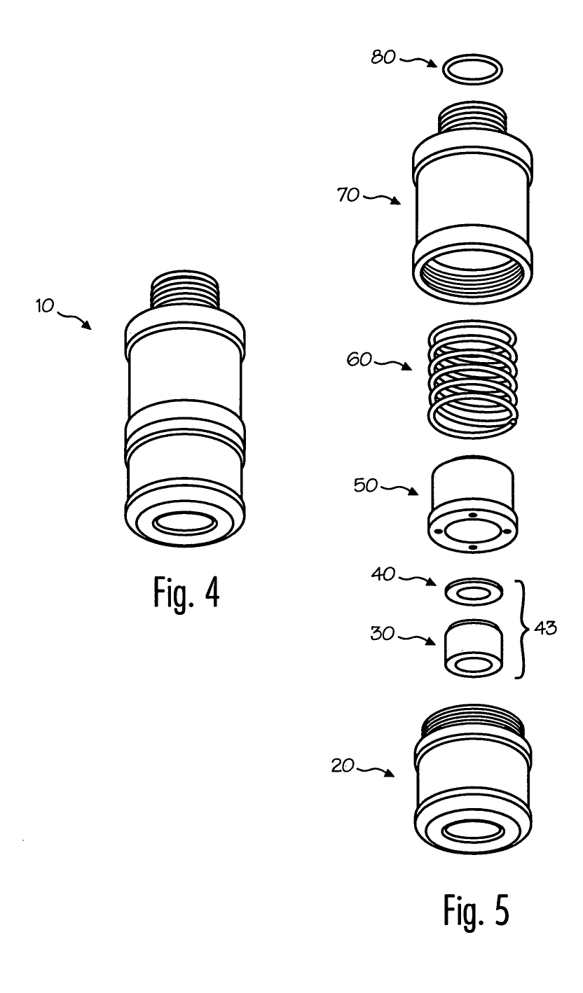

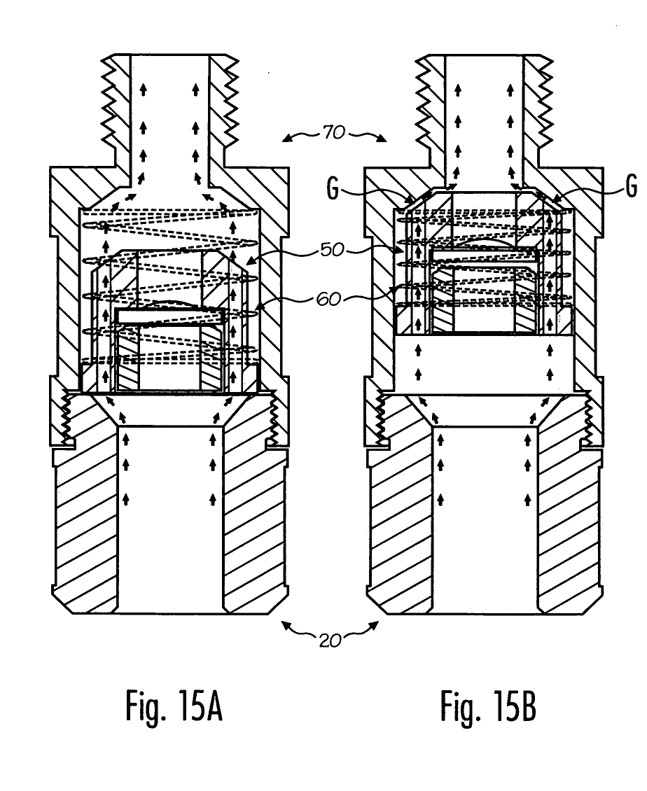

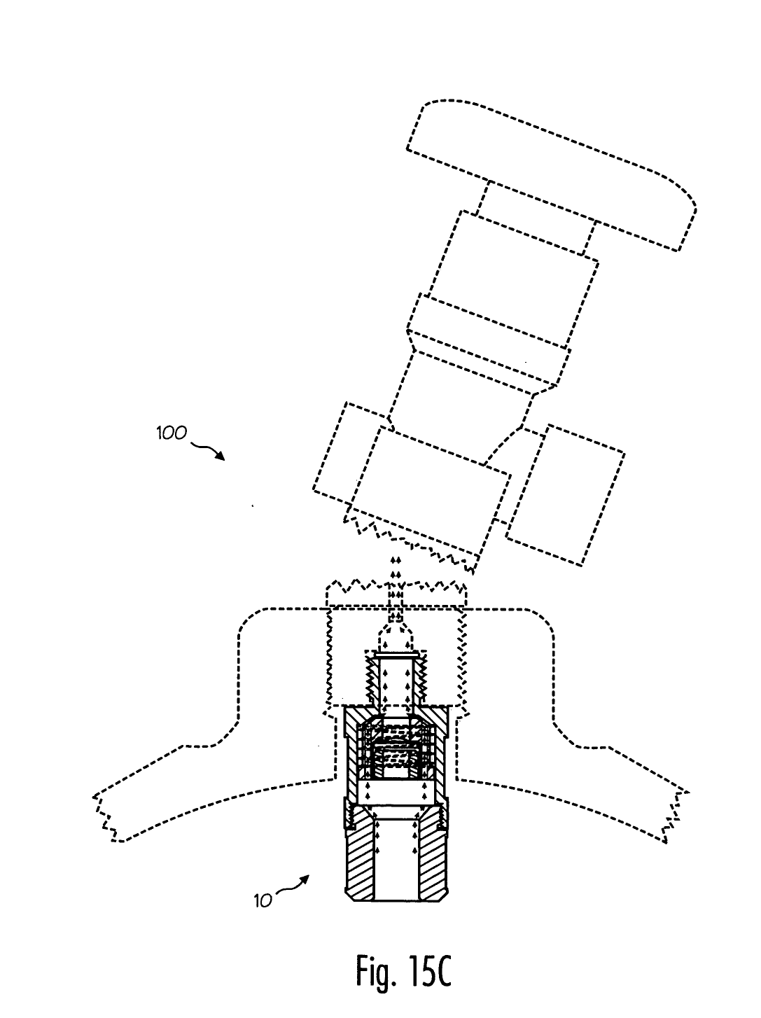

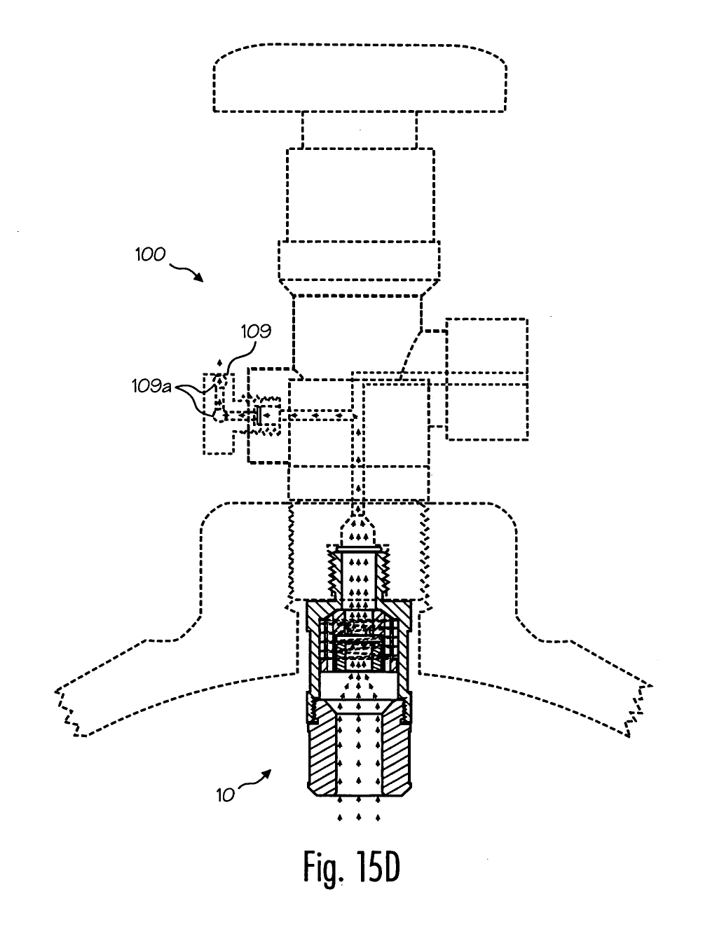

FIGS. 2 and 4 illustrate an example of the present invention as a single apparatus 10 for internal mechanical coupling to a conventional compressed content tank valve 100 through the valve's female threads 105 (as seen generally in FIG. 15D). As seen in FIGS. 2-6, the safety valve 10 of the present invention comprises, in one embodiment, a housing base 20, a rupture disc holding means 30, at least one rupture disk 40, a piston 50, a spring 60, an outer housing cylinder 70, and an optional sealing means 80.

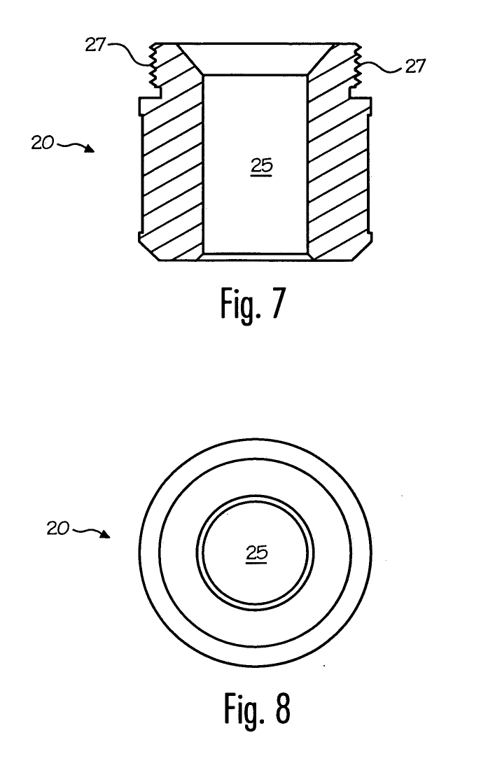

As seen in FIGS. 3 and 8, housing base 20 is a single housing apparatus of general cylindrical shape having a lower body 21 with a lower body seating surface 21a and an upper body 23. In this embodiment, as seen in FIG. 7, housing base 20 is further formed with an inner bore 25 which tapers open towards the upper body 23 of housing 20. The exterior of housing base's upper body 23 comprises male threads 27 adapted to mechanically communicate with female threads 79 formed on a lower portion of outer housing cylinder 70. The entirety of bore 25, in this embodiment, is in gas flow communication with any compressed contents which may be stored in tank 100. Further, the upper body 23 is adapted to provide a base or support means to securely retain the rupture disc assembly 45 within the outer housing cylinder 70. Those of skill in the art will recognize that while a particular housing base is disclosed, any suitable housing base 20 may be used within the present invention as long as such a housing base serves as a means to properly seat and maintain the rupture disc assembly 45 within the outer housing cylinder 70. Thus, for example, a representative housing base may be a simple press fitting made of brass or like malleable material. Alternatively, for example, another exemplary housing base may be a retaining base formed of any type of plastic, nylon or any other material which serves as a means to properly seat and maintain the rupture disc assembly 45 within the outer housing cylinder 70. Further, while a longer housing base is illustrated, those of skill in the art will recognize that shorter housing bases may be used and remain within the spirit and scope of the present invention.

As seen in FIGS. 2-6 and 9-10, optional rupture disc holding means 30 is a single housing of general cylindrical shape having a disc seating surface 31. Rupture disc holding means 30 is further formed with an inner bore 35 which is in gas flow communication with bore 25. Those of skill in the art will recognize that while a particular rupture disc holding means is disclosed, any suitable rupture disc holding means may be used within the present invention as long as such disc holding means serves to properly seat and retain the rupture disc 40 upon the disc seating surface 31. Thus, for example, a representative rupture disc holding means may be a simple press fitting made of brass or like malleable material. Alternatively, for example, another exemplary housing base may be a rupture disc holding means formed of any type of plastic, nylon or any other material which serves as a means to seat and retain the rupture disc 40 in a predetermined location within the outer housing cylinder 70. Further, while a specific disc holding means is illustrated, those of skill in the art will recognize that alternative disc holding means may be used (such as, for example, a simple retaining screw having threads which mechanically couples within optional corresponding threads formed within piston 50 and upon which the rupture disc 40 may sit) and remain within the spirit and scope of the present invention.

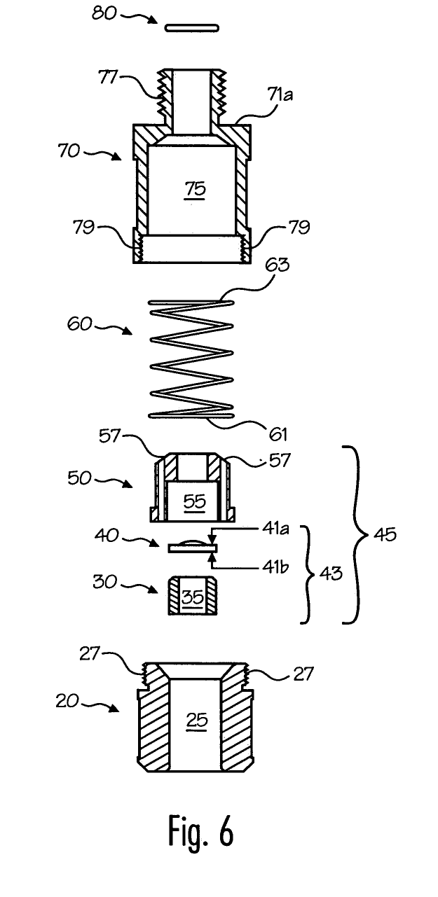

As seen in FIGS. 3 and 5, rupture disk 40 is a single disc of general cylindrical shape having an outer cylindrical base 41 integrally formed with an inner cylindrical dome. While cylindrical base 41 is integrally formed with a dome, those of skill in the art recognize that the materials comprising the cylindrical base 41 may be different that the material comprising dome. This is particularly important, because the material comprising dome may be pre-selected to rupture or fail at a pre-selected pressurized value when gas, fluid or supervapor pressure is applied to the disc's dome. Turning to FIG. 6, the outer cylindrical base 41 may be described as having an upper surface 41a and a lower surface 41b. In one preferred embodiment, the rupture disc's lower surface 41b is adapted to engagingly sit upon rupture disc holding means' seating surface 31a without mechanical coupling. In combination, the rupture disc holding means 30 and rupture disk 40 can be identified as the rupture disc seating assembly 43 as illustrated in FIG. 6. Those of skill in the art will recognize that while only one rupture disc 40 is shown in the attached figures, additional rupture discs may be employed.

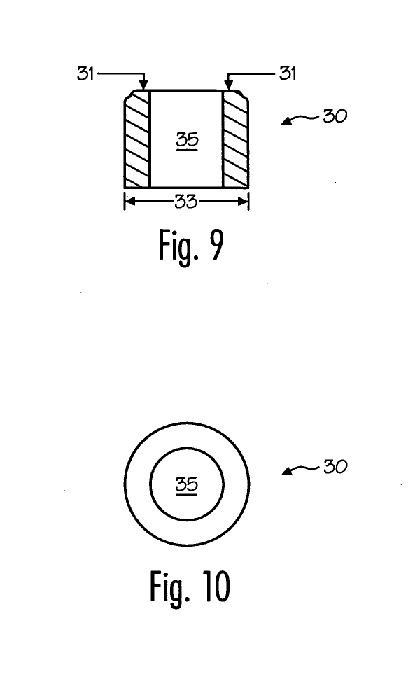

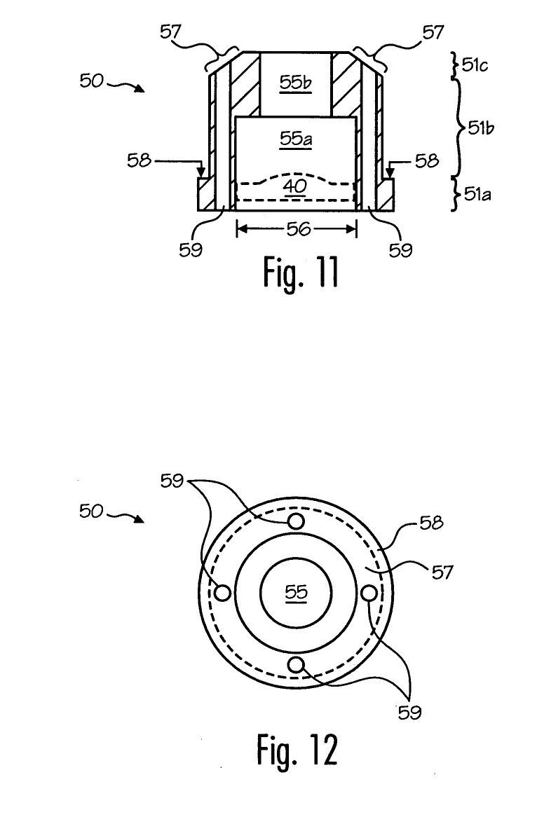

As seen in FIGS. 3, 5 and 6 and more particularly in FIGS. 11-12, piston 50 is a single housing apparatus of general cylindrical shape having an integrally formed lower body portion 51a, a middle body portion 51b and an upper body portion 51c. Piston 50 is, in one embodiment, further formed with an inner bore 55 which is wide enough 56 to receive the overall width of rupture disc seating assembly (e.g., the width shown generally as 33 in FIG. 9) and therein through a predetermined length of the piston 50, and is small enough 55b to prevent the receipt of the width of rupture disc 40 through the remaining overall length of the piston 50. At least one, and preferably a plurality of, bleeder bores 59 are formed through the exterior wall of piston 50. Piston bores 55 and bleeder bores 59 are all in gas flow communication with rupture disc holding means' inner bore 35.

As illustrated in FIG. 11, lower body portion 51a includes a piston seat surface 58. Moreover, the width of lower body portion 51a is wider than the width of middle body portion 51b. As generally seen in FIG. 6, the lower body portion 51a is adapted to sit upon (and be retained by) housing base 20. The upper body portion 51c, in this embodiment, includes a beveled cylindrical surface 57 thereon.

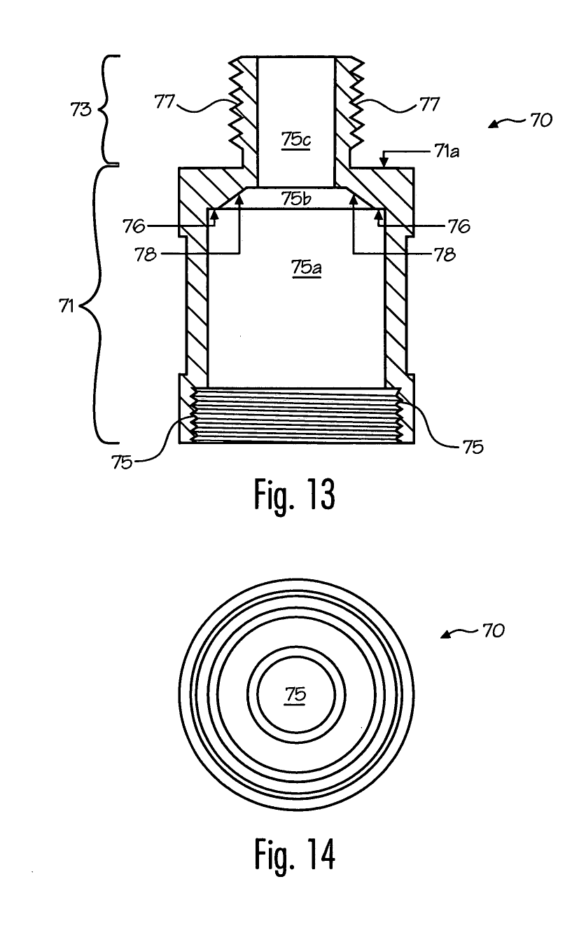

As seen in FIG. 6, spring 60 is of conventional spring design having a first end 61 and a second end 63. The spring 60 is adapted to wrap around middle body portion 51b of piston 50, while radial arm of first end 61 is adapted to sit upon piston seat surface 58. The radial arm of second end 63 is adapted to mechanically engage the upper ceiling 76 (shown in FIGS. 6 and 13) of outer housing cylinder 70. The overall length of spring 60 is adapted to fit within middle chamber bores 75a and 75b in outer housing cylinder 70 (as more further discussed below) in a substantially uncompressed fashion. Preferably, the spring 60 is adapted to have a predetermined compression value which will press against (and thereby, hold down) piston 50 during normal pressurization and use of the tank 100, and a compression value which will compress during an over-pressurization event, thereby allowing piston beveled surface 57 to mechanically engage upper beveled ceiling 78 (as further discussed herein).

As seen in FIGS. 2-6 and 13-14, outer housing cylinder 70 is a single housing apparatus of general cylindrical shape having a lower body 71 with a seat surface 71a and an upper body 73. Outer housing cylinder 70 is further formed with an inner bore 75 which is wider 75a within the lower body 71, becomes smaller 75b thought an upper tapered bore within the lower body 71, and is smallest 75c within the upper body 73 of cylinder 70. Inner bores 75a and 75b are adapted to house or otherwise receive spring 60 and the rupture disc assembly 45 therein. The lower inner portion of lower body 71 is formed with female threads 75 which are adapted to mechanically communicate with male threads 27 in housing base 20 (as generally illustrated in FIG. 5).

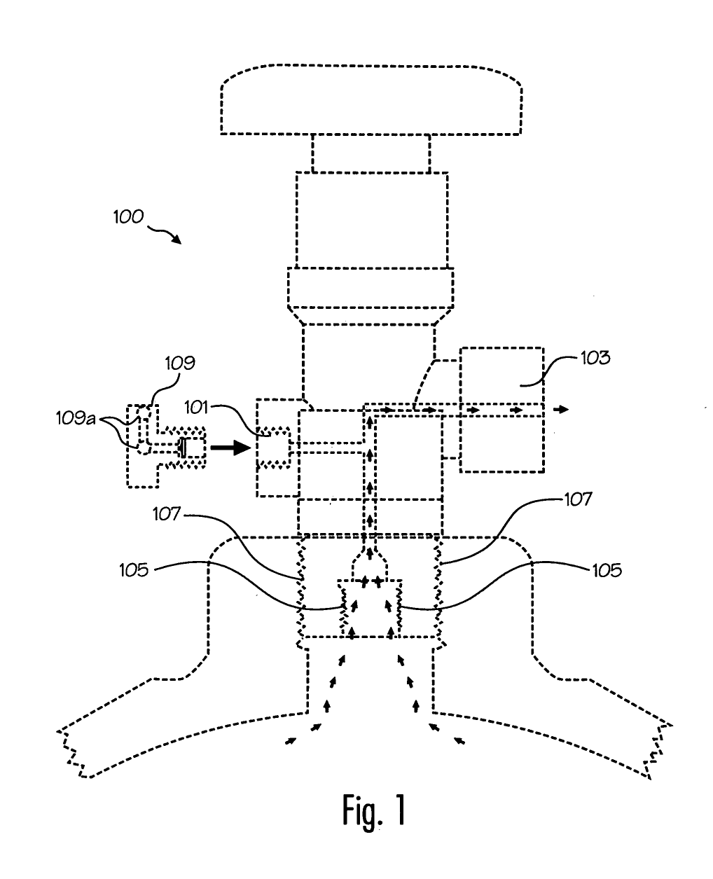

The exterior of outer housing cylinder's upper body 73 comprises male threads 77 adapted to mechanically communicate with female threads typically formed in a conventional gas cylinder (shown as element 105 in FIG. 1) for mechanical engagement of the present invention with a gas cylinder valve 100. The entirety of bore 75 is in gas flow communication with bore 25, bore 35, and bore 55. As such, those of skill in the art will recognize that bore 75 is in gas flow communication with any compressed contents which may be stored in the compressed tank. Concurrently, bore 75 is also in gas flow communication with the conventional tank's inlet/outlet port 101, so as to allow complete gas flow communication between the contents stored within the tank and any exterior gas/fluid lines or gas/fluid communication channels attached to the tank's inlet/outlet port 101.

Preferably, optional O-ring 80 is adapted to sit upon seat surface 71a of outer housing cylinder 70 and is adapted to provide an engaging gas or fluid seal between the present invention and a conventional gas tank valve's female threads 105 when coupled to the valve 100.

Of course, those of skill in the art will recognize that while the foregoing description of the present invention discusses male and female threaded components, the present invention is not limited to specific types of threaded connections and may be adapted to many different types of connections including, for example, gas straight threads, welded threads, and other connection types. Moreover, those of skill in the art will recognize that the elements disclosed in the present invention are not formed or limited to any one type of material (such as brass), but may be formed from any suitable material without detracting from the spirit of the invention (such as, for example, stainless steel, plastic, or any other composition).

FIGS. 15A-15D illustrate the several operational characteristics of the present invention as it may be coupled to a valve 100. In normal operation, an operator is allowed to identify a suitable rupture disc 40 with a predefined pressure setting, and install it for use with the present invention 10 when it is installed on a gas cylinder tank. Next, compressed gas may fill the tank to a desired level, the compressed gas flow entering the tank through bores 75, 59 55, 35 and 25. As seen in FIG. 15A, rupture disc assembly 45 sits within outer housing cylinder 70 through bore 75a. In this embodiment, spring 60 maintains a constant compression upon piston seat surface 58, so that when valve 100 is turned on, the compressed gas may flow out through bores 75, 59 55, 35 and 25.

However, as shown in FIG. 15B, during an over-pressurization event, the compressed contents of the tank will suddenly be released through all bores in the valve, thereby exerting a tremendous amount of force pressure from the tank. FIG. 15B illustrates an embodiment of the present invention 10 during an over-pressurization event. In this embodiment, gas pressure is allowed to escape from the valve 100, but the gas pressure is so high that its escape through the valve 100 does not prevent further pressurization within the tank, thereby resulting in the possibility of a tank explosion. This event could occur from a number of exterior events, such as for example, a adjacent fire (which heats up the gas or the content within the tank). This event could also occur due to the inadvertent opening of a valve 100 on a tank which does not contain a pressure regulator (thereby resulting in an uncontrolled gas escape from the tank). If an over-pressurization event occurs, the extreme force of the escaping gas places a force on the bottom surface of the rupture disc assembly 45, so that the piston's beveled cylindrical surface 57 substantially mechanically engages upper beveled ceiling 78. This mechanical engagement does not present a complete seal between surface 57 and ceiling 78, but rather, allows gas to continue to escape from the tank through bleeder bores 59 and gap G (as seen in FIG. 15B). In this regard, even through an over-pressurization event occurs, the present invention continues to allow the gas pressure from the tank to escape slowly. This embodiment is suitable to mechanically communicate with the valve's own primary rupture disc assembly 109, so that if the primary rupture disc assembly fails, the present invention's rupture disc assembly 45 serves to allow the gas to slowly escape from the over pressurized tank.

FIG. 15C illustrates another type of over-pressurization event which, in many cases, presents substantial danger to nearby persons or property. In this case, the over-pressurization event occurs because the top portion of the valve 100 (the portion sticking out from the tank) is sheared off or away. In this event, even the valve's own primary rupture disc assembly 109 is sheared away, so this primary form of allowing gas to escape an over-pressurized tank fails. However, use of the present invention serves to solve this problem. Again, if an over-pressurization event occurs, the extreme force of the escaping gas places a force on the bottom surface of the rupture disc assembly 45, so that the piston's beveled cylindrical surface 57 substantially mechanically engages upper beveled ceiling 78. This mechanical engagement does not present a complete seal between surface 57 and ceiling 78, but rather, allows gas to continue to escape from the tank through gap G (as seen in FIG. 15B). Because in operation, the present invention 10 is located within the interior of the tank (as seen in FIG. 15D, for example), it cannot be sheared off with the rest of the valve, but remains intact as a safety apparatus, method of use and system.

FIG. 15D illustrates operation of the present invention when the valve's primary rupture disc 109 fails. In this embodiment, when the primary rupture disc 109 fails, the extreme force of the escaping gas places a force on the bottom surface of the rupture disc assembly 45, so that the piston's beveled cylindrical surface 57 substantially mechanically engages upper beveled ceiling 78. This mechanical engagement does not present a complete seal between surface 57 and ceiling 78, but rather, allows gas to continue to escape from the tank through gap G (as seen in FIG. 15B).

Upon review of the present disclosure, those of skill in the art will realize that the present invention may be embodied as a system, assembly, process or apparatus. Other variations and modifications of the present invention will be apparent to those of ordinary skill in the art, and is not limited except by the appended claims. The particular designs and configurations discussed herein can be varied, and are cited to illustrate particular embodiments of the present invention. It is contemplated that the use of the present invention can involve components having different characteristics as long as the principles disclosed herein are followed.

The conventional gas or fluid tanks disclosed in the present invention are not limited to the stored content, size of the tank and/or whether the tank is portable or not. Thus, for example, the present invention may be useful when the compressed content is oxygen, argon, hydrogen, helium, methane and nitrogen (all of which can exist in either gas, fluid or as supercritical material at certain temperatures). Moreover, those of skill in the art will realize that the present invention has other utility in other applications which may not involve a tank or cylinder, but, for example, may also be used in any type of a high pressurized system.

As will be appreciated by one of ordinary skill in the art, the present invention may be embodied as a system, process or apparatus, or any combination thereof. Accordingly, the present invention may take the form of an entirely software embodiment, an entirely hardware embodiment, or an embodiment combining aspects of both software and hardware. Additionally, in the foregoing specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

Other variations and modifications of the present invention will be apparent to those of ordinary skill in the art, and it is the intent of the appended claims that such variations and modifications be covered. The particular values and configurations discussed above can be varied, are cited to illustrate representative embodiments of the present invention and are not intended to limit the scope of the invention. It is contemplated that the use of the present invention can involve components having different characteristics as long as the principle is followed.

I claim:

1. A high pressure safety valve apparatus for a compressed content container having a gas flow outlet line, the apparatus comprising a housing base having a first bore, a rupture disc assembly comprising a second bore, at least one rupture disk and a piston having a disc seating surface and at least a third bore, a spring, and an outer housing cylinder having a forth bore, an upper ceiling within the forth bore, and female threads formed on a lower portion of the outer housing cylinder, the first bore, the second bore and the third bore all being in gas flow communication with the compressed content and the gas flow outlet line, the apparatus being adapted to allow normal gas flow between the bores and the outlet line during a non-over pressurization event, the apparatus being further adapted to substantially restrict gas flow between the bores and the outlet line during an over pressurization event.

2. The apparatus of claim 1 wherein the housing base comprises a lower body with a lower body seating surface and an upper body, and wherein an exterior portion of the upper body comprises male threads adapted to mechanically communicate with the out housing cylinder's female threads.

3. The apparatus of claim 2 wherein the rupture disc holding means is adapted to seat and retain the rupture disc upon the disc seating surface.

4. The apparatus of claim 2 wherein each rupture disc is pre-selected to fail at a pre-selected pressurized value when pressure is applied to the disc.

5. The apparatus of claim 4 wherein the piston comprises an integrally formed lower body portion, a middle body portion and an upper body portion having a seat surface, the inner bore being of sufficient width to receive the rupture disc seating assembly through a predetermined length of the piston, the inner bore being of sufficient width to prevent the receipt of the rupture disc assembly through the remaining overall length of the piston, and wherein the upper body portion further comprises a beveled surface thereon.

6. The apparatus of claim 5 wherein the piston is further defined to have an exterior wall, the piston further comprising at least one bleeder bore formed in the piston exterior wall and extending through the beveled surface, the bleeder bore being a gas flow communication with the first bore, the second bore and the third bore, and wherein the lower body portion is adapted to sit upon and be retained by the housing base.

7. The apparatus of claim 6 wherein the spring has a first radial arm and a second radial arm, the spring being adapted to wrap around the piston's middle body portion, the first radial arm being adapted to sit upon the piston's upper body portion seat surface, and the second radial arm being adapted to mechanically engage the outer housing cylinder's upper ceiling, the spring further being adapted to fit within the forth bore in a substantially uncompressed fashion during a non-over pressurization event, and in a substantially compressed fashion during an over pressurization event to thereby allow the piston beveled surface to mechanically engage the outer housing cylinder's upper ceiling.

8. The apparatus of claim 7 wherein the outer housing cylinder's upper body further comprises male threads adapted to mechanically communicate with one or more female threads formed in the compressed content container.

9. The apparatus of claim 8 further comprising a O-adapted to sit upon outer housing cylinder's seat surface to provide a seal with the compressed content container's female threads.

10. A method for substantially reducing gas flow from an over-pressurized tank filled with pressurized content, the method comprising the steps of:
introducing a high pressure safety valve apparatus, the apparatus being threadably insertable into a valve which is threadably insertable into the tank, the apparatus comprising a housing base having a first bore, a rupture disc assembly comprising a second bore, at least one rupture disk and a piston having a disc seating surface and at least a third bore, a spring, and an outer housing cylinder having a forth bore, an upper ceiling within the forth bore, and female threads formed on a lower portion of the outer housing cylinder, the first bore, the second bore and the third bore all being in gas flow communication with the compressed content and the gas flow outlet line;
mechanically engaging the rupture disc assembly to allow normal gas flow between the bores and the outlet line during a non-over pressurization event; and
allowing the rupture disc assembly to substantially restrict gas flow between the bores and the outlet line during an over pressurization event.

11. The method of claim 1 wherein the housing base further comprises a lower body with a lower body seating surface and an upper body, wherein an exterior portion of the upper body comprises male threads adapted to mechanically communicate with the out housing cylinder's female threads, wherein the rupture disc holding means is adapted to seat and retain the rupture disc upon the disc seating surface, and wherein each rupture disc is pre-selected to fail at a pre-selected pressurized value when pressure is applied to the disc.

12. The method of claim 11 wherein the piston further comprises an integrally formed lower body portion, a middle body portion and an upper body portion having a seat surface, the inner bore being of sufficient width to receive the rupture disc seating assembly through a predetermined length of the piston, the inner bore being of sufficient width to prevent the receipt of the rupture disc assembly through the remaining overall length of the piston, wherein the upper body portion further comprises a beveled surface thereon, and wherein the piston is further defined to have an exterior wall, the piston further comprising at least one bleeder bore formed in the piston exterior wall and extending through the beveled surface, the bleeder bore being a gas flow communication with the first bore, the second bore and the third bore, and wherein the lower body portion is adapted to sit upon and be retained by the housing base.

13. The method of claim 12 wherein the spring has a first radial arm and a second radial arm, the spring being adapted to wrap around the piston's middle body portion, the first radial arm being adapted to sit upon the piston's upper body portion seat surface, and the second radial arm being adapted to mechanically engage the outer housing cylinder's upper ceiling, the spring further being adapted to fit within the forth bore in a substantially uncompressed fashion during a non-over pressurization event, and in a substantially compressed fashion during an over pressurization event to thereby allow the piston beveled surface to mechanically engage the outer housing cylinder's upper ceiling.

14. The method of claim 13 wherein during an over-pressurization event, the piston's beveled surface substantially mechanically engages outer housing's upper ceiling, thereby allowing content to escape from the container.

15. The product according to the method of claim 10.

16. A system for allowing content flow from a pressurized tank filled with content which substantially reduces gas flow when the tank is over pressurized, the system comprising a housing base having a first bore, a rupture disc assembly comprising a second bore, at least one rupture disk and a piston having a disc seating surface and at least a third bore, a spring, and an outer housing cylinder having a forth bore, an upper ceiling within the forth bore, and female threads formed on a lower portion of the outer housing cylinder, the first bore, the second bore and the third bore all being in gas flow communication with the compressed content and the gas flow outlet line, the piston further comprising an integrally formed lower body portion, a middle body portion and an upper body portion having a seat surface, the inner bore being of sufficient width to receive the rupture disc seating assembly through a predetermined length of the piston, the inner bore being of sufficient width to prevent the receipt of the rupture disc assembly through the remaining overall length of the piston, the upper body portion further comprising a beveled surface thereon, and wherein the spring has a first radial arm and a second radial arm, the spring being adapted to wrap around the piston's middle body portion, the first radial arm being adapted to sit upon the piston's upper body portion seat surface, and the second radial arm being adapted to mechanically engage the outer housing cylinder's upper ceiling, the spring further being adapted to maintain a constant compression upon piston disc seat surface during a non-over pressurization event, and in a substantially compressed fashion during an over pressurization event to thereby allow the piston beveled surface to mechanically engage the outer housing cylinder's upper ceiling.

17. The system of claim 16 wherein the piston is further defined to have an exterior wall, the piston further comprising at least one bleeder bore formed in the piston exterior wall and extending through the beveled surface, the bleeder bore being a gas flow communication with the first bore, the second bore and the third bore, and wherein the lower body portion is adapted to sit upon and be retained by the housing base.

18. The system of claim 17 wherein one or more of the rupture discs are adapted to fail upon a pre-selected pressure force being exerted by the pressurized contents of the container.

19. The system of claim 18 wherein the housing base, the rupture disc assembly and the outer housing cylinder are all formed of brass.

20. The system of claim 19 wherein the housing base, the rupture disc assembly and the outer housing cylinder are all generally cylindrical in shape.
